(19) United States
(12) Patent Application Publication
(10) Pub. No.: US 2021/0209982 A1
(43) Pub. Date: Jul. 8, 2021

(54) DISPLAY APPARATUS AND SHUTDOWN AFTERIMAGE ELIMINATION METHOD THEREOF

(71) Applicants: HKC Corporation Limited, Shenzhen City, Guangdong (CN); Chongqing HKC Optoelectronics Technoology Co.., Ltd., Chongqing (CN)

(72) Inventor: Wei FU, Chongqing (CN)

(21) Appl. No.: 16/064,444

(22) PCT Filed: Jan. 24, 2018
(86) PCT No.: PCT/CN2018/073935

§ 371 Date: Jun. 20, 2018

(30) Foreign Application Priority Data
Sep. 25, 2017 (CN) 201710875544.6

(51) Int. Cl. G09G 3/20

(52) U.S. Cl. CPC G09G 3/20; G09G 2320/0257; G09G 2310/0278

(57) ABSTRACT

A display apparatus includes: a substrate; a plurality of scanning lines, disposed thereon; a plurality of data lines, disposed on the substrate and being crossed with the scanning lines to define pixel regions; a plurality of active switches, disposed on the substrate within the pixel regions, where a control end of each active switch is coupled to one of the scanning lines, a first end is coupled to one of the data lines, and a second end is coupled to a common electrode voltage; a plurality of control switches, disposed on the substrate, where a first end of each control switch is coupled to a data line, a second end is coupled to the common electrode voltage, and a control end is coupled to a gate voltage; and on/off states of the control switches are regulated by a voltage difference between the gate voltage and the common electrode voltage.

### BACKGROUND

### Technical Field

This application relates to an afterimage elimination method, and in particular, to a display apparatus and a shutdown afterimage elimination method thereof.

### Related Art

A liquid crystal display (LCD) apparatus has been widely applied recently. Along improvement of a drive technology, the LCD apparatus has advantages of low power consumption, a thin shape and a light weight, and low voltage drive and has been widely applied to various projection devices such as a camcorder, a laptop computer, and a desktop display apparatus.

In addition, the LCD apparatus usually includes a gate driver circuit, a source driver circuit, and a pixel array. The pixel array includes a plurality of pixel circuits. Each pixel circuit is switched on or off according to a scanning signal provided by the gate driver circuit and displays a data picture according to a data signal provided by the source driver circuit.

Limited by a charge/discharge speed of liquid crystal, some charges may remain on a liquid crystal panel during shutdown, and consequently, human eyes may see a shutdown afterimage. A currently common practice is generating a control signal during shutdown, so that a gate drive chip (Gate Driver) turns on TFT switches of all channels at the same time, to discharge the charges as soon as possible. However, in this case, because output of a data drive chip (Data Driver) is uncertain, discharge effects would differ due to different picture display data. Therefore, the method cannot ensure complete elimination of residual charges. Therefore, to improve a technical defect when the foregoing common gate drive chip discharges the liquid crystal panel, a shutdown afterimage elimination method having low manufacturing costs and easy to process is provided.

### SUMMARY

To resolve the foregoing technical problem, an objective of this application is to provide a display apparatus and a shutdown afterimage elimination method thereof. A control switch is added, so that voltages at two ends of an active switch are the same after a shutdown signal is activated, so as to output black picture data, eliminate a possibility of a shutdown afterimage, and improve quality of a display picture.

The objective of this application is achieved and the technical problem of this application is resolved by using the following technical solutions. A display apparatus provided according to this application comprises: a substrate; a plurality of scanning lines, disposed on the substrate; a plurality of data lines, disposed on the substrate and configured in a manner of being crossed with the scanning lines to define a plurality of pixel regions; a plurality of active switches, disposed on the substrate and located within the pixel regions, where a control end of each of the active switches is coupled to one of the scanning lines, a first end is coupled to one of the data lines, and a second end is coupled to a common electrode voltage; a plurality of control switches, disposed on the substrate, where a first end of each of the control switches is coupled to a data line, a second end is coupled to the common electrode voltage, and a control end is coupled to a gate voltage; and on/off states of the control switches are regulated by using a voltage difference between the gate voltage and the common electrode voltage.

The technical problem of this application may be further resolved by taking the following technical measures.

In an embodiment of this application, when the gate voltage is at a first potential, the first potential is greater than or equal to the common electrode voltage, and when the gate voltage is at a second potential, the second potential is a 0 potential.

In an embodiment of this application, when the gate voltage is at the first potential, the second end and the control end of the control switch are conducted, and the first end and the second end of the control switch are disconnected,

In an embodiment of this application, when the gate voltage is at the second potential, the first end and the second end of the control switch are conducted, and the first end and the second end of the active switch are both connected to the common electrode voltage.

In an embodiment of this application, the control switch is a P-type field effect transistor.

In an embodiment of this application, the display apparatus further comprises: a plurality of display capacitors, disposed in the pixel regions and connected to the second ends of the active switches and the common electrode voltage. The display capacitor comprises a liquid crystal capacitor and a pixel storage capacitor.

In, an embodiment of this application, the display apparatus further comprises: a plurality of grounding resistors, where the grounding resistors are connected to the control ends of the control switches.

In an embodiment of this application, the control switches are disposed at source ends of the data lines and are connected to a data drive chip.

Another objective of this application is a shutdown afterimage elimination method of a display apparatus, comprising: regulating on/off states of control switches by using a voltage difference between a gate voltage and a common electrode voltage; coupling active switches to the control switches by using data lines; conducting a first end and a second end of the control switch when the gate voltage is at a second potential being a 0 potential; and connecting both a first end and a second end of the active switch to the common electrode voltage, where a voltage difference between two ends of the active switch is 0, a display panel outputs a black picture.

In an embodiment of this application, the control switch is a P-type field effect transistor.

In an embodiment of this application, a plurality of display capacitors is further included, is disposed in the pixel regions, and is connected to the second ends of the active switches and the common electrode voltage.

In an embodiment of this application, the display capacitor comprises a liquid crystal capacitor and a pixel storage capacitor.

In an embodiment of this application, a plurality of grounding resistors is further included, where the grounding resistors are connected to the control ends of the control switches.

In an embodiment of this application, the control switches are disposed at source ends of the data lines and are connected to a data drive chip. The data drive chip is disposed on the display panel in a chip-on-film manner.

Still another objective of this application is a display apparatus, comprising: a substrate; a plurality of scanning lines, disposed on the substrate; a plurality of data lines, disposed on the substrate and configured in a manner of being crossed with the scanning lines to define a plurality of pixel regions; a plurality of active switches, disposed on the substrate and located within the pixel regions, where a control end of each of the active switches is coupled to one of the scanning lines, a first end is coupled to one of the data lines, and a second end is coupled to a common electrode voltage; a plurality of control switches, disposed on the substrate, where a first end of each of the control switches is coupled to a data line, a second end is coupled to the common electrode voltage, a control end is coupled to a gate voltage, and the control switch is a P-type field effect transistor; and a plurality of grounding resistors, where the grounding resistors are connected to the control ends of the control switches and the gate voltage, where when the gate voltage is at a first potential, the first potential is greater than or equal to the common electrode voltage, and when the gate voltage is at a second potential, the second potential is a 0 potential; and when the gate voltage is at the first potential, the second end and the control end of the control switch are conducted, and the first end and the second end of the control switch are disconnected; when the gate voltage is at the second potential, the first end and the second end of the control switch are conducted, and the first end and the second end of the active switch are both connected to the common electrode voltage.

According to this application, a control switch is added, so that voltages at two ends of an active switch are the same after a shutdown signal is activated, so as to output black picture data, eliminate a possibility of a shutdown afterimage, and improve quality of a display picture.

### BRIEF DESCRIPTION OF THE DRAWINGS

FIG. 1 is a schematic diagram of an exemplary LCD panel formed by an LCD pixel array;

FIG. 2 is a schematic diagram of an exemplary LCD pixel in an LCD panel and an equivalent capacitive load of a related switch component;

FIG. 3 is a schematic diagram of another exemplary LCD pixel in an LCD panel and an equivalent capacitive load of a related switch component;

FIG. 4 is a schematic working diagram of an exemplary gate drive chip;

FIG. 5 is a schematic diagram of a display apparatus according to an embodiment of this application;

FIG. 6 is a schematic diagram of a part of a shutdown drive circuit according to an embodiment of this application; and

FIG. 7 is a schematic diagram of a control switch according to an embodiment of this application.

### DETAILED DESCRIPTION

The following embodiments are described with reference to the accompanying drawings, and are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located above or below a target component and does not mean that the component needs to be located on the top based on a gravity direction.

To further describe the technical measures and functions used in the this application to achieve the predetermined invention objectives, specific implementations, structures, features, and functions of a display apparatus and a shutdown afterimage elimination method thereof provided in this application are described in detail below with reference to the accompanying drawings and preferred embodiments.

A display panel in this application may include an active array (thin film transistor, TFT) substrate, a color filter (CF) substrate, and a liquid crystal layer formed between the two substrates.

In an embodiment, the display panel in this application may be a curved-surface display panel.

In an embodiment, the active array (TFT) and the CF in this application may be formed on a same substrate.

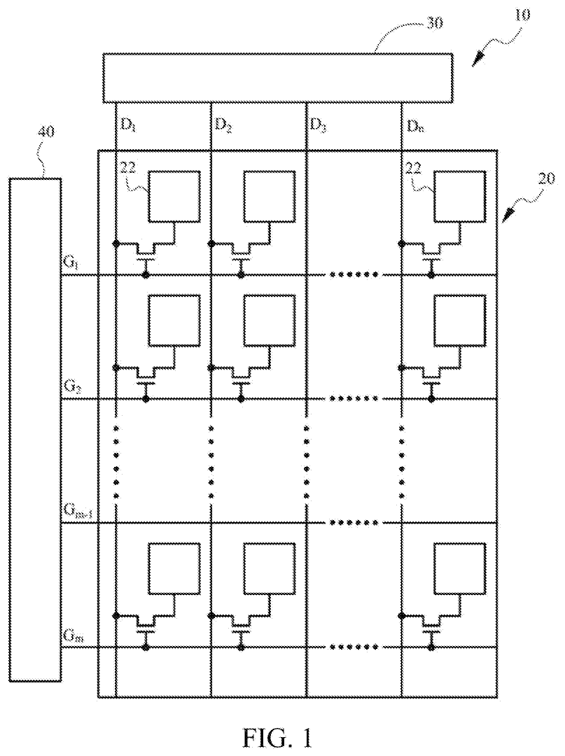

FIG. 1 is a schematic diagram of an exemplary LCD panel formed by an LCD pixel array. Referring to FIG. 1, an LCD panel 10 includes a display module 20 including a plurality of pixels 22 and 22′ arranged in a two-dimensional array. The pixels are controlled and driven by a plurality of data lines D1, D2 . . . Dn and a plurality of gate lines G1, G2 . . . Gm. A data signal of each data line is provided by a data drive chip 30, and a gate signal of each gate line is provided by a gate drive chip 40.

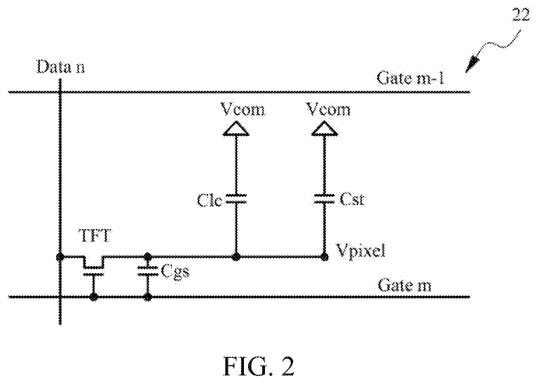

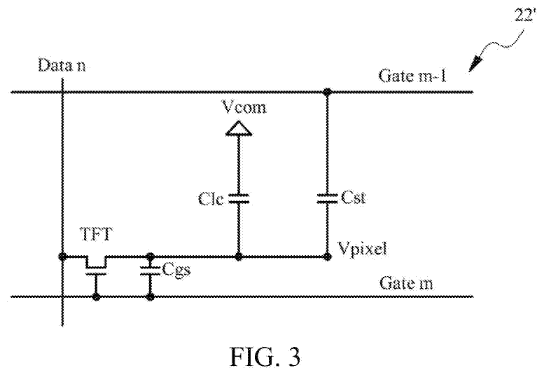

FIG. 2 is a schematic diagram of an exemplary LCD pixel in an LCD panel and an equivalent capacitive load of a related switch component; FIG. 3 is a schematic diagram of another exemplary LCD pixel in an LCD panel and an equivalent capacitive load of a related switch component. Referring to FIG. 2 and FIG. 3, each pixel 22 or 22′ is related to a plurality of capacitors, for example, a capacitor Clc formed by and related to a liquid crystal layer capacitor located between upper and lower layer electrodes, an extra charge storage capacitor Cst that maintains a voltage at a Vpixel value after a signal located at a gate line is passed, and a capacitor Cgs related to a gate end and a data end of a switch component (an active switch, TFT). A total capacitance value of a pixel of an LCD panel may change due to impact of a size of the pixel, a thickness of a liquid crystal layer, a size of a storage capacitor, and other several technologies well known to a person skilled in the art. As shown in FIG. 2, Clc and Cst are both connected to a common voltage Vcom. As shown in FIG. 3. Cst is connected to a gate line.

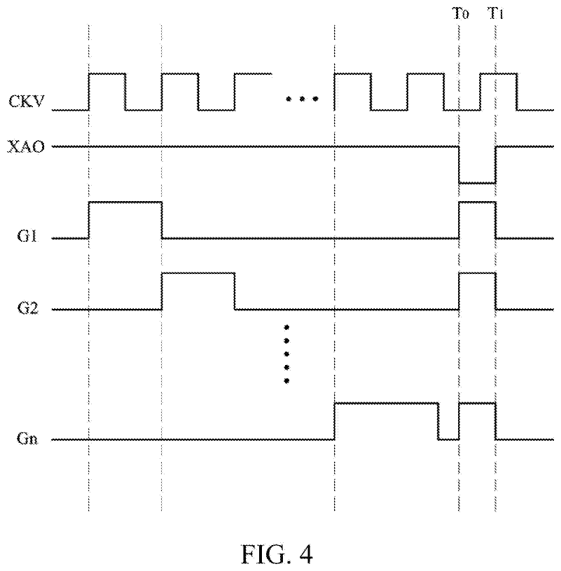

Limited by a charge/discharge speed of liquid crystal, some charges may remain on a liquid crystal panel during shutdown, and consequently, human eyes see a shutdown afterimage. As shown in FIG. 4, a common practice is generating a control signal during shutdown, so that the gate drive chip 40 turns on TFT switches of all channels at the same time, to discharge the charges as soon as possible. However, in this case, because output of the data drive chip 30 is uncertain, discharge effects would differ due to different picture display data. Therefore, the method cannot ensure complete elimination of residual charges.

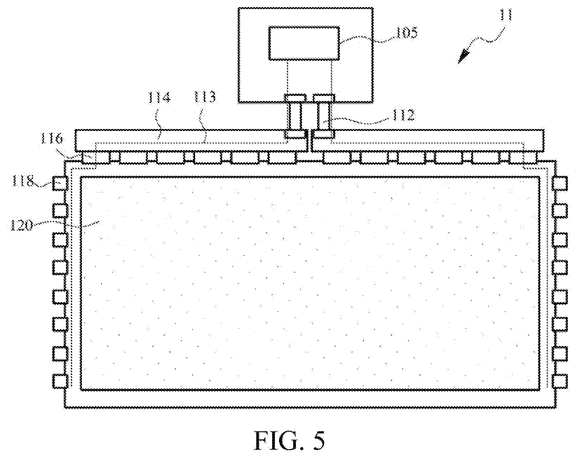

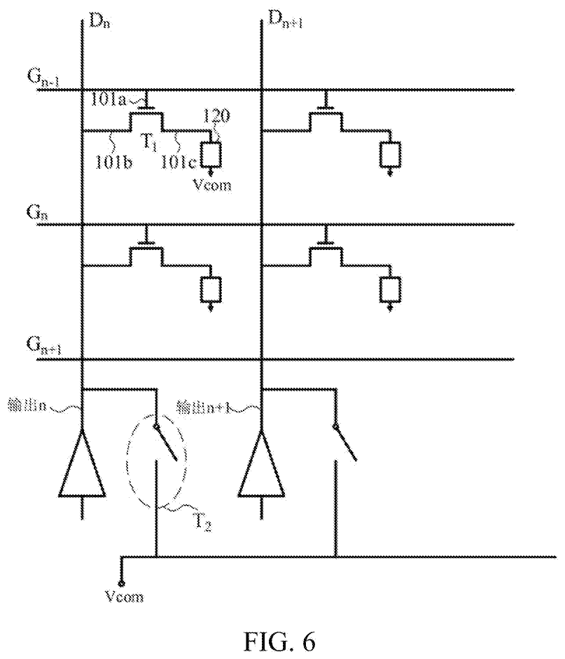

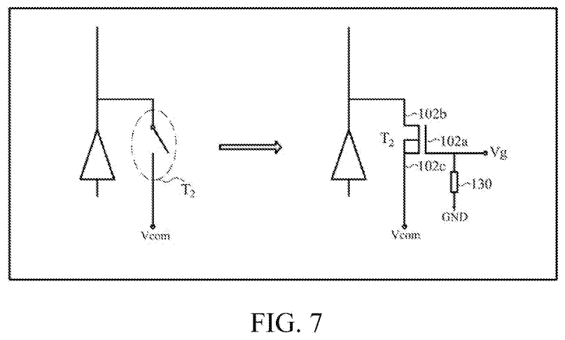

FIG. 5 is a schematic diagram of a display apparatus according to an embodiment of this application; FIG. 6 is a schematic diagram of a part off shutdown drive circuit according to an embodiment of this application; FIG. 7 is a schematic diagram of a control switch according to an embodiment of this application. Referring, to FIG. 5, FIG. 6, and FIG. 7, in an embodiment of this application, a display apparatus 11 includes: a substrate (not shown in the figures); a plurality of scanning lines Gn, disposed on the substrate; a plurality of data lines Dn, disposed on the substrate and configured in a manner of being crossed with the scanning lines to define a plurality of pixel regions, n being a positive number; a plurality of active switches T1, disposed on the substrate and located within the pixel regions, where a control end 101a of each of the active switches is coupled to one of the scanning lines, a first end 101b is coupled to one of the data lines, and a second end 101c is coupled to a common electrode voltage Vcom; and a plurality of control switches T2, disposed on the substrate, where a first end 102b of each of the control switches T2 is coupled to a data line, a second end 102c is coupled to the common electrode voltage, and a control end 102a is coupled to a gate voltage Vg. On/off states of the control switches T2 are regulated by using a voltage difference between the gate voltage Vg and the common electrode voltage Vcom.

In an embodiment, when the gate voltage Vg is at a first potential, the gate voltage Vg is greater than or equal to the common electrode voltage Vcom; when the gate voltage Vg is at a second potential, the gate voltage Vg is at a 0 potential.

In an embodiment, when the gate voltage Vg is at the first potential, the second end 102c and the control end 102a of the control switch T2 are conducted, and the first end 102b and the second end 102c of the control switch T2 are disconnected.

In an embodiment, when the gate voltage Vg is at the second potential, the first end 102b and the second end 102c of the control switch T2 are conducted, and the first end 101b and the second end 101c of the active switch T1 are both connected to the common electrode voltage Vcom.

In an embodiment, the control switch T2 may be, for example, a P-type field effect transistor. The control switch T2 may be a field effect transistor switch of another type, for example, a CMOS transistor or an NMOS transistor.

In an embodiment, the display apparatus 11 further includes: a plurality of display capacitors 120, disposed in the pixel regions and connected to the second ends 101c of the active switches T1 and the common electrode voltage Vcom. The display capacitor 120 may include, for example, a liquid crystal capacitor and a pixel storage capacitor.

In an embodiment, the display apparatus 11 further includes: a plurality of grounding resistors 130, where one end of the grounding resistor 130 is connected to a ground GND, and the other end is connected to the control end 102a of the control switch T2, to assist the gate voltage Vg quickly complete potential switching.

In an embodiment, the control switches T2 are disposed at source ends of the data lines and are connected to a data drive chip 116. The data drive chip 116 may be disposed on a display panel in, for example, a chip-on-film (COF) manner.

Referring to FIG. 5, in an embodiment, in an overall drive architecture of a display panel, a power control chip 105 generates a control signal 113, and the control signal 113 then passes through a soft flat cable 112, a drive board 114, and a line on glass and is finally transmitted to the data drive chip 116 and a gate drive chip 118. In a normal state, the control signal 113 is at a high potential (H). When the power control chip 105 detects shutdown, the control signal 113 is reduced to a low potential (L). When the control signal 113 changes from a high potential (H) to a low potential (L), the gate voltage Vg is triggered to be switched from a first potential to a second potential (a 0 potential). In addition, the grounding resistors 130 may assist the gate voltage Vg be more quickly switched to the second potential, so as to conduct the first end 102b and the second end 102c of the control switch T2, so that two ends (101b, 01c) of the active switch T1 are both connected to the common electrode voltage Vcom, so as to eliminate a shutdown afterimage.

Referring to FIG. 5 and FIG. 6, in an embodiment of this application, a shutdown afterimage elimination method of a display apparatus 11 includes: regulating on/off states of control switches T2 by using a voltage difference between a gate voltage Vg and a common electrode voltage Vcom; and coupling active switches T1 to the control switches T2 by using data lines Dn, to control a connection state of a first end 102b and a second end 102c of the active switch T2.

When the gate voltage Vg is at first potential, the gate voltage Vg is greater than or equal to the common electrode voltage Vcom, a second end 102c and a control end 102a of the control switch T2 are conducted, and a first end 102b and the second end 102c of the control switch T2 are disconnected. That is, a display panel is in a normal display state.

When the gate voltage Vg is at a second potential, the gate voltage Vg is at a 0 potential, and the first end 102b and the second end 102c of the control switch T2 are conducted. Further, the first end 101b and the second end 101c of the active switch T1 are both connected to the common electrode voltage Vcom, and a voltage difference between two ends (101b, 101c) of the active switch T1 is 0. Therefore, there is no voltage difference, or the voltage difference is 0, so that liquid crystal corresponding to each pixel 22 stops deviation, and light of a backlight source cannot pass through a polarizer. Consequently, the display panel outputs a black picture. In this way, even if the backlight source is not immediately completed turned off during shutdown due to a capacitor or an inductance effect, because liquid crystal does not have a deviation angle, the display panel outputs a black picture. Eyes of an observer also see a black picture, and no afterimage appears. This fundamentally resolves a problem of shutdown afterimages.

In an embodiment of this application, a display apparatus 11 includes: a control component (for example, a multi-band antenna) (not shown in the figure) and further includes the display panel 120 (for example, a quantum dots light-emitting diode (QLED) panel or an organic light-emitting diode (OLED) panel or an LCD panel. However, this is not limited herein, and the display apparatus 11 may also be a plasma display panel and the like.

According to this application, a control switch is added, so that voltages at two ends of an active switch are the same after a shutdown signal is activated, so as to output black picture data, eliminate a possibility of a shutdown afterimage, and improve quality of a display picture.

Phrases such as “in some embodiments” and “in various embodiments” are repeatedly used. The phrases usually refer to different embodiments, but they may also refer to a same embodiment. Words such as “comprise”. “have”, and “include” are synonyms, unless other meanings are indicated in the context.

The foregoing descriptions are merely embodiments of this application, and are not intended to limit this application in any form. Although this application has been disclosed above through the embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A display apparatus, comprising:
a substrate;
a plurality of scanning lines, disposed on the substrate;
a plurality of data lines, disposed on the substrate and configured in a manner of being crossed with the scanning lines to define a plurality of pixel regions;
a plurality of active switches, disposed on the substrate and located within the pixel regions, wherein a control end of each of the active switches is coupled toto one of the scanning lines, a first end is coupled toto one of the data lines, and a second end is coupled toto a common electrode voltage; and
a plurality of control switches, disposed on the substrate, wherein a first end of each of the control switches is coupled toto a data line, a second end is coupled toto the common electrode voltage, and a control end, is coupled toto a gate voltage; and
on/off states of the control switches are regulated by using a voltage difference between the gate voltage and the common electrode voltage.

2. The display apparatus according to claim 1, wherein when the gate voltage is at a first potential, the first potential is greater than or equal to the common electrode voltage. 3, The display apparatus according to claim 2, wherein when the gate voltage is at the first potential, the second end and the control end of the control switch are conducted.

4. The display apparatus according to claim 2, wherein when the gate voltage is at the first potential, the first end and the second end of the control switch are disconnected.

5. The display apparatus according to claim 1, wherein when the gate voltage is at a second potential, the second potential is a 0 potential.

6. The display apparatus according to claim 5, wherein when the gate voltage is at the second potential, the first end and the second end of the control switch are conducted.

7. The display apparatus according to claim 5, wherein when the gate voltage is at the second potential, the first end and the second end of the active switch are both connected to the common electrode voltage.

8. The display apparatus according to claim 1, wherein the control switch is a P-type field effect transistor.

9. The display apparatus according to claim 1, further comprising: a plurality of display capacitors, disposed in the pixel regions and connected to the second ends of the active switches and the common electrode voltage.

10. The display apparatus according to claim 9, wherein the display capacitor comprises a liquid crystal capacitor and a pixel storage capacitor.

11. The display apparatus according to claim 1, further comprising: a plurality of grounding resistors, wherein the grounding resistors are connected to the control ends of the control switches.

12. The display apparatus according to claim 1, wherein the control switches are disposed at source ends of the data lines and are connected to a data drive chip.

13. A shutdown afterimage elimination method of a display apparatus, comprising:
regulating on/off states of control switches by using a voltage difference between a gate voltage and a common electrode voltage;
coupling active switches to the control switches by using data lines;
conducting a first end and a second end of the control switch when the gate voltage is at a second potential being a 0 potential; and
connecting both a first end and a second end of the active switch to the common electrode voltage, wherein a voltage difference between two ends of the active switch is 0, a display panel outputs a black picture.

14. The shutdown afterimage elimination method of a display apparatus according to claim 13, wherein the control switch is a P-type field effect transistor.

15. The shutdown afterimage elimination method of a display apparatus according to claim 13, further comprising: a plurality of display capacitors disposed in pixel regions and connected to the second ends of the active switches and the common electrode voltage.

16. The shutdown afterimage elimination method of a display apparatus according to claim 15, wherein the display capacitor comprises a liquid crystal capacitor and a pixel storage capacitor.

17. The shutdown afterimage elimination method of a display apparatus according to claim 13, further comprising: a plurality of grounding resistors, wherein the grounding resistors are connected to the control ends of the control switches.

18. The shutdown afterimage elimination method of a display apparatus according to claim 13, wherein the control switches are disposed at source ends of the data lines and are connected to a data drive chip.

19. The shutdown afterimage elimination method of a display apparatus according to claim 18, wherein the data drive chip is disposed on the display panel in a chip-on-film manner.

20. A display apparatus, comprising:
a substrate;
a plurality of scanning lines, disposed on the substrate;
a plurality of data lines, disposed on the substrate and configured in a manner of being crossed with the scanning lines to define a plurality of pixel regions;
a plurality of active switches, disposed on the substrate and located within the pixel regions, wherein a control end of each of the active switches is coupled to one of the scanning lines, a first end is coupled to one of the data lines, and a second end is coupled to a common electrode voltage;
a plurality of control switches, disposed on the substrate, wherein a first end of each of the control switches is coupled to a data line, a second end is coupled to the common electrode voltage, a control end is coupled to a gate voltage, and the control switch is a P-type field effect transistor; and
a plurality of grounding resistors, wherein the grounding resistors are connected to the control ends of the control switches and the gate voltage, wherein
when the gate voltage is at a first potential, the first potential is greater than or equal to the common electrode voltage, and when the gate voltage is at a second potential, the second potential is a 0 potential; and
when the gate voltage is at the first potential, the second end and the control end of the control switch are conducted, and the first end and the second end of the control switch are disconnected; when the gate voltage is at the second potential, the first end and the second end of the control switch are connected, and the first end and the second end of the active switch are both connected to the common electrode voltage.
